(19) United States
(12) Patent Application Publication
(10) Pub. No.: US 2026/0333153 A1
(43) Pub. Date: Oct. 22, 2026

(54) METHOD, DEVICE, AND MEDIUM FOR HANDOVER FAILURE MINIMIZATION SERVICE

(71) Applicant: Verizon Patent and Licensing Inc., Basking Ridge, NJ (US)

(72) Inventors: Farid Khafizov, Plano, TX (US); Artur Safin, Dallas, TX (US); Jonathan Popa, Richardson, TX (US); Art Zaifman, Millburn, NJ (US)

(21) Appl. No.: 19/180,584

(22) Filed: Apr. 16, 2025

(51) Int. Cl. H04W 36/00; H04W 36/30

(52) U.S. Cl. CPC H04W 36/0079; H04W 36/305

(57) ABSTRACT

A method, a network device, and a non-transitory computer-readable storage medium are described in relation to a handover failure minimization service. The handover failure minimization service may include minimizing false negative predictions pertaining to handovers. The handover failure minimization service may be implemented to include a model that applies a binary classification to handover prediction. The handover failure minimization service may obtain and use feature values indicative of handover failure. The handover failure minimization service may select a candidate target access device that has a lowest probability of handover failure or a historically lowest handover failure rate.

### BACKGROUND

Development and design of networks present certain challenges from a network-side perspective and an end device perspective. For example, the establishment and maintenance of end device connectivity in a radio network environment present technical challenges. In a wireless network, diverse types of handovers may be implemented, such as inter-radio access technology (RAT) handovers and intra-RAT handovers, among others, which help provide and maintain suitable wireless service to end devices.

### BRIEF DESCRIPTION OF THE DRAWINGS

FIG. 1 is a diagram illustrating an exemplary environment in which an exemplary embodiment of a handover failure minimization service may be implemented;

FIG. 2 is a diagram illustrating another exemplary environment in which an exemplary embodiment of the handover failure minimization service may be implemented;

FIG. 3 is a flow diagram illustrating an exemplary process of an exemplary embodiment of the handover failure minimization service;

FIG. 4 is a flow diagram illustrating another exemplary process of an exemplary embodiment of the handover failure minimization service;

FIG. 5A is a flow diagram illustrating yet another exemplary process of an exemplary embodiment of the handover failure minimization service;

FIG. 5B is a diagram illustrating yet another exemplary environment in which an exemplary embodiment of a handover failure minimization service may be implemented; and

FIG. 6 is a diagram illustrating exemplary components of a device that may correspond to one or more of the devices illustrated and described herein.

### DETAILED DESCRIPTION

The following detailed description refers to the accompanying drawings. The same reference numbers in different drawings may identify the same or similar elements. Also, the following detailed description does not limit the invention.

Typically, a wireless station, such as a next generation Node B (gNB), an enhanced Node B (eNB), or the like may evaluate load, radio frequency (RF) conditions, among other criteria, and when certain conditions are met (e.g., thresholds, etc.), the wireless station may initiate a handover procedure. However, current approaches to handovers may not consider many other factors that may significantly impact the success or failure of a handover. For example, additional handover predictors may include key performance indicator (KPI) values of a pre-serving cell, the serving cell, and the target cell. Additionally, handover prediction algorithms may typically focus on handover success rates. However, this approach may not yield optimal results in view of the set of possible handover outcomes. For example, according to a binary confusion matrix, the four possible results between actual and predicted classifications (e.g., handover outcomes) include a true positive (TP) (e.g., actual and predicted classifications are positive), a true negative (TN) (e.g., actual and predicted classifications are negative), a false positive (FP) (e.g., predicted classification is positive and the actual classification is negative), and a false negative (FN) (e.g., predicted classification is negative and the actual classification is positive).

According to exemplary embodiments, a handover failure minimization service is described. According to an exemplary embodiment, the handover failure minimization service may apply a binary classification to handover prediction in which incorrect predictions may be minimized. For example, the handover failure minimization service may minimize false negative predictions in which predicted handover successes are actual handover failures. Additionally, or alternatively, the handover failure minimization service may minimize false positive (FP) predictions in which predicted handover failures are actual handover successes.

According to an exemplary embodiment, the handover failure minimization service may apply a separation threshold value for the binary classifiers. According to an exemplary embodiment, the separation threshold value is based on a nonparametric test, such as the Kolmogorov-Smirnov (KS) test, as described herein. The separation threshold value may minimize a false negative rate (FNR) (e.g., FN/(FN+TP)) and sustain accuracy for correctly predicted positive instances (e.g., a true positive rate (TPR)) (e.g., TP/(TP+FN)) while diminishing incorrectly predicted instances.

According to an exemplary embodiment, the handover failure minimization service may be implemented to include a machine learning (ML) model. According to an exemplary embodiment, the feature selection for the ML model includes handover preparation attempts between the source cell and the target cell. For example, the feature selection may include inter-frequency X2 handover preparation attempts, intra-frequency X2 handover preparation attempts, inter-frequency Xn handover preparation attempts, or intra-frequency Xn handover preparation attempts, depending on the context of the prospective handover procedure. The feature selection may include other features, as described herein.

According to an exemplary embodiment, the handover failure minimization service may include a feature reduction algorithm. For example, the feature reduction algorithm may reduce redundant features that may have similar intents based on their respective gain and statistics, as described herein. In this way, complexity and inference time of the ML model may be reduced.

According to an exemplary embodiment, the handover failure minimization service may provide that a serving wireless station may evaluate handover failure probability for one or multiple candidate target wireless stations, and select the candidate target wireless station with the lowest probability of handover failure to which a handover is directed. According to an exemplary embodiment, when the serving wireless station determines that no candidate target wireless station satisfies a threshold probability of handover failure value, the source or serving wireless station may not attempt a handover.

According to another exemplary embodiment, the handover failure minimization service may provide that a serving wireless station may evaluate handover failure probability for multiple candidate target wireless stations. The serving wireless station may select the candidate target wireless station with the lowest probability of handover failure to which a handover is directed. However, when the probability of handover failures is comparable between the candidate target wireless stations, the serving wireless station may select the candidate target wireless station with the most consistent handover performance in previous handover procedures.

According to yet another exemplary embodiment, the handover failure minimization service may provide that a serving wireless station may evaluate handover failure probability for multiple candidate target wireless stations. The serving wireless station may select the candidate target wireless station with the lowest probability of handover failure to which a handover is directed. However, when the probability of handover failures is comparable between the candidate target wireless stations, the source or serving wireless station may select the candidate target wireless station based on a historical performance of handovers (e.g., best performance) from the source cell to each candidate target wireless station and one or more pre-serving wireless stations relative to the serving wireless station. In this way, KPIs associated with historical end devices and pre-serving wireless stations may supplement the selection of the candidate target wireless station for the handover.

In view of the foregoing, the handover failure minimization service may minimize handover failures based on a minimization of incorrect handover predictions, an optimal threshold value selection for binary classifiers, selection of feature importance for the ML model that may yield the lowest handover failure probability, and KPIs associated with historical pre-serving wireless stations, as described herein.

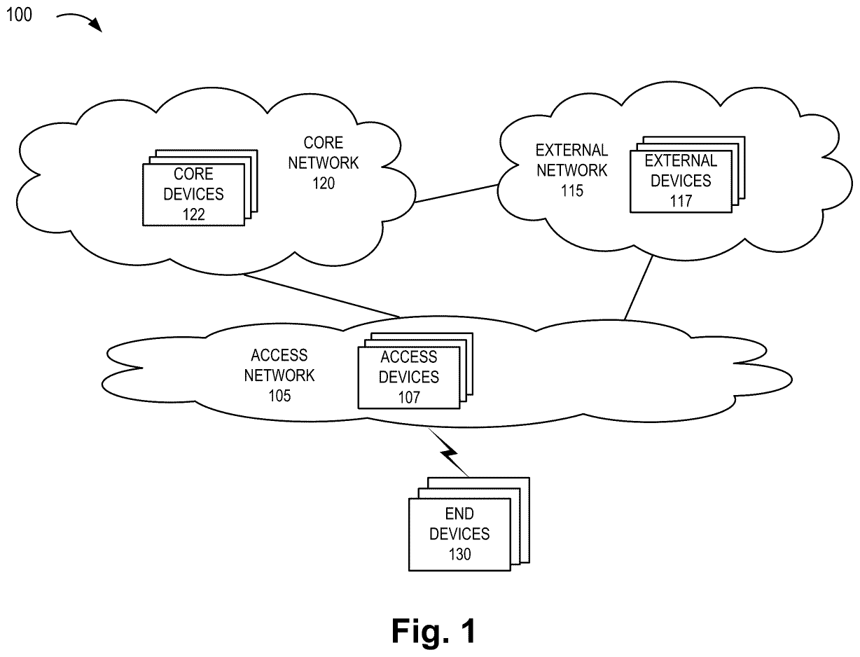

FIG. 1 is a diagram illustrating an exemplary environment 100 in which an exemplary embodiment of handover failure minimization service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), an optical network, a wired network, etc.), a time-sensitive network (TSN) system, a deterministic networking (DetNet) network, or another type of network that may support a wireless service and/or an application service, as described herein.

A network device, a network element (NE), or a network function (NF) (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, etc.), as well as used to support other types of network elements (e.g., network slices, quality of service (QoS) flows, packet data unit (PDU) sessions, channels, network paths, tunnels, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communication connection may not involve an intermediary device and/or an intermediary network. The number, type, and arrangement of communication links illustrated in environment 100 are exemplary.

Environment 100 may include various planes of communication including, for example, a control plane, a user plane, a service plane, a network management plane, an artificial intelligence and/or a machine learning (AI/ML) (control) plane, and a future generation plane, or a subset thereof. Environment 100 may include other types of planes of communication. A message communicated in support of the handover failure minimization service may use at least one of these planes. For example, the message of an exemplary embodiment of handover failure minimization service may use the control plane for handover requests to access devices 107 and handover commands to end devices 130. According to various exemplary implementations, the interface of the network device may be a service-based interface (SBI), a reference point-based interface, an Open Radio Access Network (O-RAN) interface, a 5G interface, another generation of interface (e.g., 5G Advanced, 6G, 7G, 4G, etc.), or some other type of network interface (e.g., proprietary, etc.).

Access network 105 may include one or multiple networks of one or multiple types and technologies. For example, access network 105 may be implemented to include a terrestrial network, a non-terrestrial network (e.g., a satellite network, an air-based network, etc.), or a combination thereof. By way of further example, access network 105 may include a 5G RAN, a future generation RAN (e.g., a 5G Advanced RAN, a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a 4G or 4.5 RAN (Long Term Evolution (LTE) Advanced (LTE-A), LTE Advanced Pro (LTE-A Pro), etc.). Access network 105 may communicate with and/or include other types of access networks, such as, for example, a Wi-Fi® network, a local area network (LAN), a Citizens Broadband Radio System (CBRS) network, a cloud RAN, an O-RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service. Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a gNB, an enhanced LTE (eLTE) eNB, an eNB, a radio network controller (RNC), a radio intelligent controller (RIC), a base station (BS), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN gNB (O-gNB), O-RAN eNB (O-eNB)), a 5G ultra-wide band (UWB) node, a future generation wireless access device (e.g., a 5G Advanced wireless station, a 6G wireless station, a 7G wireless station, or another generation of wireless station), or another type of cellular wireless station. Access devices 107 may also include a network device that provides a transport service (e.g., routing and forwarding), such as a router, a switch, or another type of layer 3 (e.g., network layer of the Open Systems Interconnection (OSI) model) network device.

According to some exemplary implementations, access device 107 may include a combined functionality of multiple RATs (e.g., 4G and 5G functionality, 5G and 5G Advanced functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

According to various exemplary implementations, access device 107 may include one or multiple antennas. The antenna may be implemented according to various configurations, such as single input single output (SISO), single input multiple output (SIMO), multiple input single output (MISO), multiple input multiple output (MIMO), massive MIMO, three dimensional (3D) and adaptive beamforming (also known as full-dimensional agile MIMO), two dimensional (2D) beamforming, antenna spacing, tilt (relative to the ground), radiation pattern, directivity, elevation, planar arrays, and so forth. Depending on the implementation, access device 107 may provide a wireless access service at a cell, a sector, a sub-sector, carrier, and/or other configurable level. For example, the sub-sector/zone level may include multiple divisions of a geographic area of a sector relative to access device 107. By way of further example, the sector may be divided based on proximity to the antenna of access device 107 (e.g., near, mid, far) and/or another criterion. According to another example, radio coverage of a location may be divided based on a Military Grid Reference System (MGRS) or another type of grid system to produce geo-bins. The size and/or shape of each geo-bin may be configurable. The size and/or the shape of a geo-bin may depend on the types of access device 107 (e.g., small cell device versus gNB, etc.), attributes of access device 107 (e.g., antenna configuration, radio frequency band of beam, etc.), and/or other factors (e.g., terrain of the radio covered locale).

According to an exemplary embodiment, at least some of access devices 107 include logic of an exemplary embodiment of the handover failure minimization service, as described herein. According to an exemplary embodiment, the logic of the handover failure minimization service may include one or multiple ML models that evaluate handover failure probabilities associated with one or multiple target access devices 107 regarding a prospective handover. For example, a source access device 107 may use one or multiple ML models that may evaluate handover failure for one or multiple target access devices 107. Source access device 107 may select the target access device 107 with the lowest probability of handover failure for end device 130.

According to an exemplary embodiment, the ML model may be configured for handover prediction in which incorrect predictions are minimized. For example, false negative predictions (e.g., prediction of handover (HO) success when an actual HO will fail) may be minimized. In this regard, a HO failure is a positive event and a HO success is a negative event. According to an exemplary embodiment, the classification threshold for the binary classification is optimized towards the minimization of the false negative rate (FNR) with little to no impact on the overall accuracy of correctly predicting handover successes and handover failures. According to other exemplary embodiments, both false negative predictions and false positive predictions (e.g., prediction of HO failure when an actual HO will be successful) may be minimized or false positive predictions only may be minimized.

According to an exemplary embodiment, the features used by the ML model may include features that contribute to HO failure. According to an exemplary embodiment, the features include a feature of HO preparation attempts between source and target access devices 107 in which the feature has a significant feature gain score. As previously described, depending on the context between source and target access devices 107, the HO preparation attempt feature may be an inter-frequency HO or an intra-frequency HO, and an X2 interface or an Xn interface depending on the type of access devices 107 (e.g., eNB versus gNB, etc.), for example. According to other exemplary embodiments, the features that contribute to HO failure may include other features, such as a target cell bearer drop percentage, a target cell frequency, a target cell abnormal release of UE percentage, and/or other types of features of importance indicative of HO failure based on their feature gain scores.

According to an exemplary embodiment, the features used by the ML model may be configured based on a feature reduction algorithm. For example, the feature reduction algorithm may reduce redundant features that may have similar intents based on their respective gain and statistics, as described herein. For example, there may be multiple candidate features pertaining to radio frequency (RF) conditions, such as a first candidate feature for reference signal received power (RSRP) associated with a connection of end device 130 (e.g., in decibel milliwatt (dBm)) and a second candidate feature for signal-to-interference-plus-noise ratio (SINR) associated with a connection of end device 130 in which both candidate features relate to signal strength. According to another example, a first candidate feature may be bearer drop percentage for a target cell, and a second candidate feature may be an abnormal UE release percentage in which both candidate features relate to call drops for the target cell.

According to an exemplary embodiment, when two features are considered to be similar in intent, the feature reduction algorithm may be used. According to an exemplary embodiment, the feature reduction algorithm may be performed according to the exemplary expressions provided herein, including:
Consider two features fₘ=feature_{A} and fₖ=feature_{B}.
Select N sample data sets (e.g., markets). Computer feature gain scores for each sample:
   Gain score for feature_{A}: gₘ₁, . . . , g_{mN}
   Gain score for feature_{B}: gₖ₁, . . . , g_{kN}
Compute the mean and the variation for each set of gain scores:

$${\overline{g}}_{m} = \frac{1}{N} {\sum }_{i} {g}_{m i}$$

$${\overline{g}}_{k} = \frac{1}{N} {\sum }_{i} {g}_{ki}$$

$$Var ( {f}_{m} ) = \frac{1}{N} {\sum }_{i}^{N} {( {\overline{g}}_{m} - {g}_{m i} )}^{2} ,$$

$$Var ( {f}_{k} ) = \frac{1}{N} {\sum }_{i}^{N} {( {\overline{g}}_{k} - {g}_{k i} )}^{2}$$

Select fₘ=feature_{A} and drop fₖ=feature_{B} if:
         |g̅ₘ−g̅ₖ|<ϵ AND Varₘ>Varₖ+Δ
      where ϵ is a predetermined parameter and A is a predetermined parameter. The values of both parameters ϵ and Δ may be fine-tuned by network administrators, engineers, or another appropriate person or entity. In this example, since the gain difference is small (e.g., ϵ) but the variation of gₖ samples is significant, and consequently there is more uncertainty in gₖ values than E(fₘ) values, fₘ=feature_{A} may be selected.

According to an exemplary embodiment, the ML model may include a binary classification model. According to an exemplary embodiment, the handover failure minimization service may use a supervised learning approach. For example, the ML model(s) may be implemented to include a logistic regression algorithm, a decision tree algorithm, a Random Forest algorithm, a Naïve Bayes algorithm, a Support Vector Machine (SVM) algorithm, neural network (NN) algorithm, or the like that provides binary classification for handover prediction. According to some exemplary embodiments, the handover failure minimization service may use an optimization algorithm, such as a reinforcement learning algorithm for successful handover prediction. According to some exemplary embodiments, the handover failure minimization service may use an ensemble learning method (e.g., multiple models).

According to an exemplary embodiment, the handover failure minimization service may provide that source access device 107 may evaluate handover failure probability for one or multiple candidate target access devices 107, and select the candidate target access device 107 with the lowest probability of handover failure to which a handover is directed.

According to an exemplary embodiment, the logic of the handover failure minimization service may include a threshold probability of handover failure value. For example, access device 107 may compare a probability of handover failure output by the ML model to the threshold probability of handover failure value. When the threshold probability of handover failure value is satisfied, access device 107 may forego the handover procedure. In this way, if the ML model predicts a significant probability of handover failure, access device 107 may prevent the execution of the handover. According to some exemplary embodiments, end device 130 may search for other candidate target access devices 107 that may yield a satisfactory probability of success (i.e., a low probability of handover failure as compared to other candidates).

According to another exemplary embodiment, when candidate target access devices 107 have comparable probabilities of handover failure, which satisfy the threshold probability of handover failure, source access devices 107 may select the target access device 107 with the highest historic success rate for handover performance or the lowest handover failure rate.

According to yet another exemplary embodiment, when candidate target access devices 107 have comparable probabilities of handover failure, which satisfy the threshold probability of handover failure value, source access device 107 may select the target access device 107 based on a historical performance of handover from source access device 107 to each candidate target access device 107. Additionally, source access device 107 may consider one or more pre-serving access devices 107 relative to serving access device 107. In this way, source access device 107 may afford priority to a target access device 107 that has the best handover performance (e.g., historically lowest handover failure rate) based on a shared history of prior connections associated with pre-serving access device(s) 107 to source/serving access device 107 to target access device 107. In this regard, the mobility of end device 107 from pre-serving access device(s) 107 to source/serving access device 107 to target access device 107 and the resulting handover performance may determine which candidate target access device 107 is selected, as described herein.

External network 115 may include one or multiple networks of one or multiple types and technologies that provide an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an IP Multimedia System (IMS) network, a Rich Communication Service (RCS) network, a software defined (SD) network, a virtual network, a packet-switched network, a data center, or other type of network that may provide access to and may host an end device application service or a network application service.

Depending on the implementation, external network 115 may include various network devices such as external devices 117. For example, external devices 117 may include virtual network devices (e.g., virtualized network functions (VNFs), servers, host devices, containers, hypervisors, virtual machines (VMs), network function virtualization infrastructure (NFVI), and/or other types of virtualization elements, layers, hardware resources, operating systems, engines, etc.) that may be associated with application services for use by end devices (not illustrated). By way of further example, external devices 117 may include mass storage devices, data center devices, NFV devices, SDN devices, cloud computing devices, platforms, and other types of network devices pertaining to various network-related functions, as described herein. External network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., ultra-low-cost network, etc.), enhanced mobile broadband (eMBB), higher user mobility (e.g., high speed train, remote computing, moving hot spots, etc.), Internet of Things (IoT) services (e.g., smart wearables, sensors, mobile video surveillance, smart cities, connected home, massive IoT (mIoT), critical IoT (cIoT), etc.), extreme real-time communications (e.g., tactile Internet, augmented reality (AR), virtual reality (VR), eXtended reality (XR), mixed reality (MR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, conferencing, instant messaging), video streaming, gaming (e.g., cloud gaming (CG), etc.), and/or other types of wireless and/or wired application services.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM) device, a unified data repository (UDR), an authentication server function (AUSF), a network slice selection function (NSSF), a network repository function (NRF), a policy control function (PCF), a network data analytics function (NWDAF), a network exposure function (NEF), a service communication proxy (SCP), a Time Sensitive Communication and Time Sensitive Function (TSCTCF), a future generation core device (e.g., a 5G-Advanced core device, a 6G core device, a 7G core device, etc.), a service capability exposure function (SCEF), a lifecycle management (LCM) device, an application function (AF), a mobility management entity (MME), a packet gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and a charging system (CS), or a sub-combination thereof. Additionally, core devices 122 may include transport devices (e.g., routers or the like), and a transport control device, such as a path computation engine (PCE).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-generation functionality (e.g., 4G and 5G, 5G and 5G Advanced, 5G and 6G, etc.), such as an SMF with PGW control plane functionality (e.g., SMF+PGW-C), a UPF with PGW user plane functionality (e.g., UPF+PGW-U), and/or other types of combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

End device 130 includes a device that may have communication capabilities (e.g., wireless, wired, optical, etc.). End device 130 may have computational capabilities. End device 130 may be implemented as a mobile device, a portable device, a stationary device (e.g., a non-mobile device or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, etc.), a computer (e.g., laptop, palmtop, etc.), a gaming device, a music device, an IoT device, a drone, a smart device, a television, a media player or streaming device, a telematics device, or another type of wireless device (e.g., another type of UE). End device 130 may be configured to execute various types of software (e.g., applications, programs, etc.) that enable access and use of various application services, as described herein. The number and the types of software may vary among end devices 130. For purposes of description, end device 130 is not considered a network device.

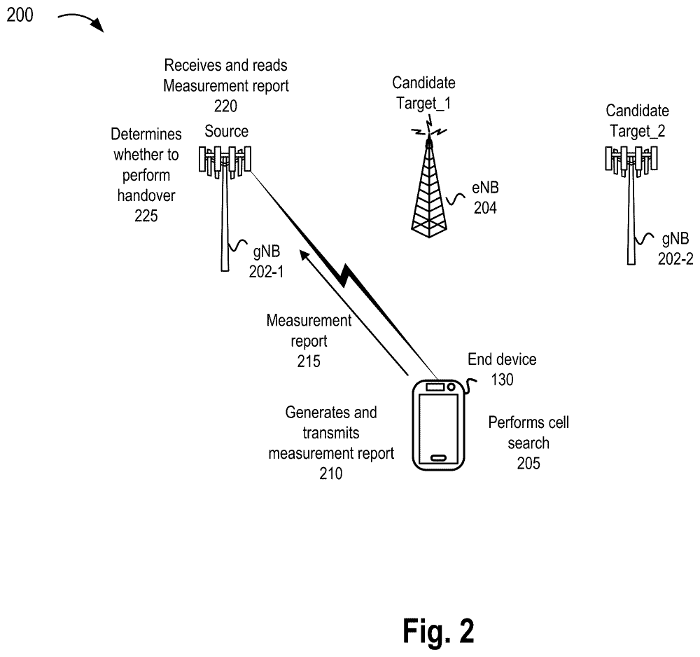

FIG. 2 is a diagram illustrating an exemplary environment 200 of an exemplary embodiment of the handover failure minimization service. As illustrated, environment 200 may include exemplary access devices 107, such as a gNB 202-1 (e.g., source access device 107; source), an eNB 204 (e.g., target access device 107-1; candidate target 1), and a gNB 202-2 (e.g., target access device 107-2; candidate target 2). Environment 200 may further include end device 130. As described in relation to FIG. 1, according to other exemplary embodiments, the environment may include another type of access device 107 (i.e., source and/or candidate target) not specifically illustrated and described in FIG. 2. Additionally, the number of access devices 107 is exemplary. According to an exemplary embodiment, gNB 202-1 is configured with an exemplary embodiment of the handover failure minimization service, as described herein.

Referring to FIG. 2, assume that a wireless connection (e.g., a radio resource control (RRC) connection) has been established between end device 130 and gNB 202-1 (e.g., source access device 107). Subsequently, end device 130 may be triggered to perform a cell search based on a search trigger. For example, the event may relate to current reference signal received quality (RSRQ) and/or RSRP values associated with a source cell or frequency of gNB 202-1 to which end device 130 is connected. End device 130 may perform a cell search 205 including obtaining downlink measurements relating to cells of eNB 204 and gNB 202-2 (e.g., candidate target access devices 107). The downlink measurements may include RSRQ values and/or RSRP values. Based on a measurement report criteria, according to this exemplary scenario, end device 130 generates and transmits 210 a measurement report 215 to gNB 202-1. As further illustrated in FIG. 2, gNB 202-1 may receive and read 220 the measurement report 220, and may determine whether to perform a handover 225. Although not illustrated, source and target access devices 107 may exchange information including one or multiple feature values, as described herein.

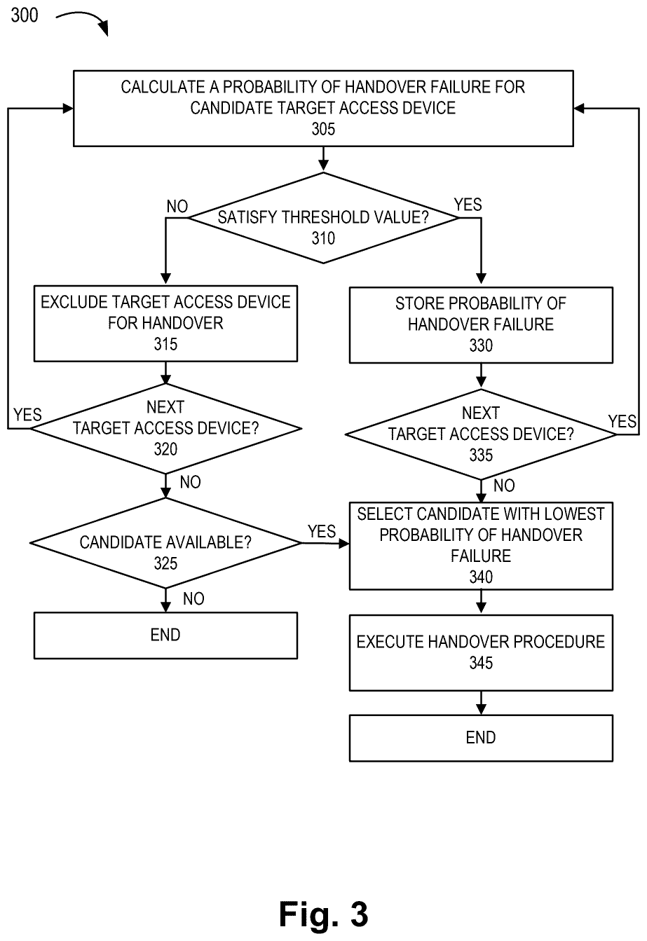

FIGS. 3-5 are flow diagrams that illustrate exemplary processes of exemplary embodiments of the handover failure minimization service. For example, the processes may be performed by a source access device 107, such as gNB 202-1 for making a handover decision.

FIG. 3 is a flow diagram illustrating an exemplary process 300 of an exemplary embodiment of the handover failure minimization service. According to an exemplary embodiment, source access device 107, as described herein, may perform a step of process 300. According to an exemplary embodiment, source access device 107 includes an ML model that provides the handover failure minimization service, as described herein.

In block 305, source access device 107 may calculate a probability of handover failure for a candidate target access device 107. For example, the ML model of the handover failure minimization service may calculate the probability of handover failure based on the configured binary classification and one or more features of relevance relating to the candidate target access device 107 of the prospective handover, as described herein. According to an exemplary embodiment, source access device 107 may determine to invoke a handover decision procedure in response to receipt and analysis of a measurement report from end device 130 and radio resource management (RRM) information. The handover decision procedure may include calculating the probability of handover failure for each candidate target access device 107, among other steps, as described herein.

In block 310, source access device 107 may determine whether the probability of handover failure value satisfies a threshold probability of handover failure value. For example, source access device 107 may compare the probability of handover failure value output by the ML model to the threshold probability of handover failure value.

When the probability of handover failure value does not satisfy the threshold probability of handover failure value (block 310-NO), source access device 107 may exclude the candidate target access device 107 for the handover (block 315). For example, the threshold probability of handover may indicate a high degree or significant probability for handover failure (e.g., 70% chance or another probability value). Accordingly, the source access device 107 may exclude the candidate target access device 107 when the probability value is equivalent to or exceeds the threshold probability of handover failure.

In block 320, source access device 107 may determine whether there is another candidate target access device 107 for consideration. When source access device 107 determines there is another candidate target access device 107 (block 320-YES), then process 300 may continue and return to block 305. When source access device 107 determines there is not another candidate target access device 107 (block 320-NO), source access device 107 may determine whether there is a candidate available (block 325). For example, when source access device 107 determines, based on block 330, that there is at least one candidate target access device 107 (block 325-YES), source access device 107 may proceed to block 340. Block 340 is described further below. When source access device 107 determines there is not a candidate available (block 325-NO), process 300 may end. According to some exemplary implementations, end device 130 may perform another search for another set of candidate target access device(s) 107. If no suitable candidate target access device 107 is found, but access network 105 determines the handover to be necessary, then the best candidate target access device 107 will be selected for the handover.

Referring back to block 310, when the probability of handover failure value does satisfy the threshold probability of handover failure value (block 310-YES), source access device 107 may store the probability of handover failure value (block 330).

In block 335, source access device 107 may determine whether there is another candidate target access device 107 for consideration. When source access device 107 determines there is another candidate target access device 107 (block 335-YES), then process 300 may continue and return to block 305. When source access device 107 determines there is not another candidate target access device 107 (block 335-NO), source access device 107 may select the candidate target access device 107 with the lowest probability of handover failure (block 340). For example, when there are multiple candidate target access devices 107 to consider, source access device 107 may compare the probability of handover failure values and select the target access device 107 having the lowest probability of handover failure value based on the comparison. According to another example, when there is only a single candidate target access device 107, then source access device 107 may select the sole candidate target access device 107 as the target access device 107 for handover.

In block 345, source access device 107 may execute a handover procedure with the selected target access device 107. For example, source access device 107 may generate and transmit a handover request to the target access device 107. In response to receiving and reading the handover request, target access device 107 may perform an admission control procedure. Target access device 107 may generate and transmit a handover acknowledgement to source access device 107. In response to receiving and reading the handover acknowledgement, source access device 107 may generate and transmit a handover command, which may include an RRC configuration relating to the handover, to end device 130. Process 300 may end.

FIG. 3 illustrates an exemplary process 300 of the handover failure minimization service, according to other exemplary embodiments, the handover failure minimization service may perform additional operations, fewer operations, and/or different operations than those illustrated and described.

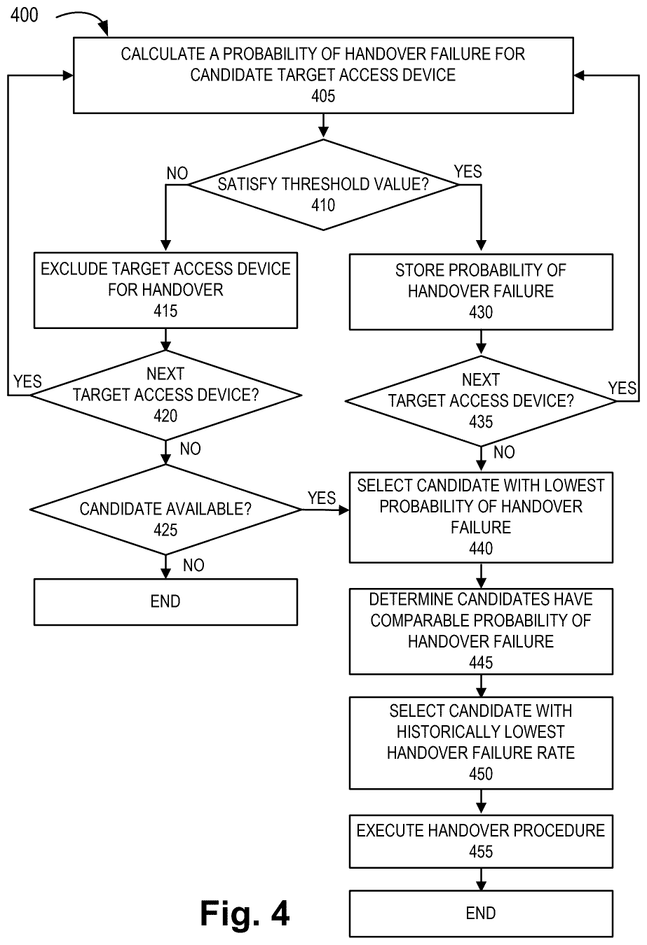

FIG. 4 is a flow diagram illustrating an exemplary process 400 of an exemplary embodiment of the handover failure minimization service. According to an exemplary embodiment, source access device 107, as described herein, may perform a step of process 400. According to an exemplary embodiment, source access device 107 includes an ML model that provides the handover failure minimization service, as described herein.

For purposes of brevity, block 405 through block 440 may include steps or operations similar to those illustrated and described in relation to block 305 through block 340 of FIG. 3 and will not be repeated. Referring to FIG. 4, in block 440, in contrast to block 340 of FIG. 3, according to another example, when there are multiple candidate target access devices 107 to consider, source access device 107 may compare the probability of handover failure values and determine that there is not a lowest probability of handover failure value (block 445). For example, two or more probability of handover failure values may be equivalent or have a negligible difference.

In block 450, source access device 107 may select the candidate target access device 107 with the historically lowest handover failure rate. For example, source access device 107 may determine and compare the handover failure rate for previous handovers between source access device 107 and each candidate target access device 107. Based on the result of the comparison, source access device 107 may select the candidate target access device 107 with the lowest handover failure rate.

In block 455, source access device 107 may execute a handover procedure with the selected target access device 107. The handover procedure may include steps or operations previously described in relation to block 345 of FIG. 3. Process 400 may end.

FIG. 4 illustrates an exemplary process 400 of the handover failure minimization service, according to other exemplary embodiments, the handover failure minimization service may perform additional operations, fewer operations, and/or different operations than those illustrated and described.

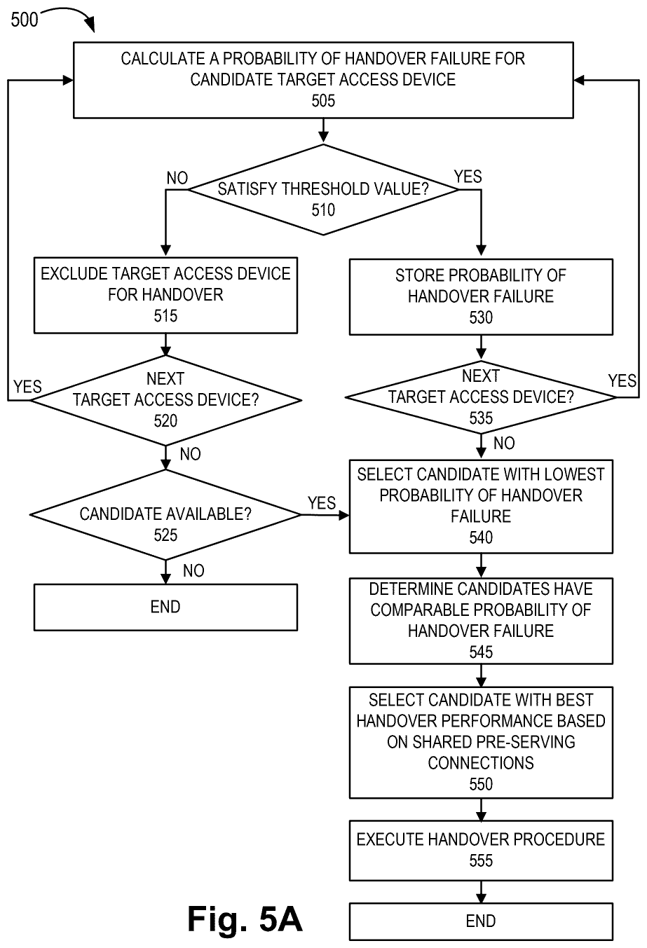

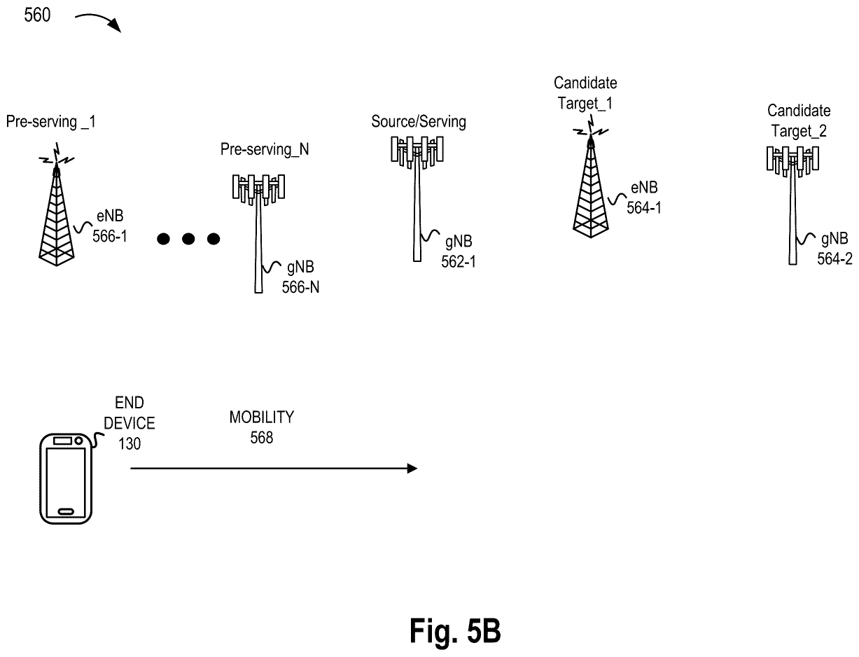

FIG. 5A is a flow diagram illustrating an exemplary process 500 of an exemplary embodiment of the handover failure minimization service. According to an exemplary embodiment, source access device 107, as described herein, may perform a step of process 500. According to an exemplary embodiment, source access device 107 includes or calls upon an ML model that provides the handover failure minimization service, as described herein.

For purposes of brevity, block 505 through block 545 may include steps or operations similar to those illustrated and described in relation to block 405 through block 445 of FIG. 4 and will not be repeated.

Referring to FIG. 5A, in block 550, source access device 107 may select the candidate with the best handover performance based on historical handover performance between source access device 107 and each candidate target access device 107, and shared pre-serving connections. For example, referring to FIG. 5B, in which an exemplary environment 560 is illustrated. In this example, a gNB 562-1 may be the source/serving access device 107, and eNB 564-1 and gNB 564-2 may each be candidate target access devices 1 and 2. As further illustrated, eNB 566-1 through gNB 566-N may be considered pre-serving access devices 107 relative to source/serving access device 107 in view of the mobility 568 of end device 130. The number of pre-serving access devices 107 is exemplary. For example, there may be a single pre-serving access device 107 or multiple (e.g., 2 or more) pre-serving access devices 107. For purposes of illustration and description, one or multiple pre-serving access devices 107 may be included in environment 200 of FIG. 2 relative to source/serving access device 107 (e.g., gNB 202-1).

According to an exemplary embodiment, the logic of handover failure minimization service of source access device 107 may include obtaining one or more KPIs from one or multiple pre-serving access devices 107. According to an exemplary embodiment, the KPI(s) may relate to a bearer drop percentage, an abnormal UE release percentage, physical resource block (PRB) utilization percentage, and the like that may be indicative of a handover failure during a historical time period (e.g., previous hour or another time period). In this way, the ML model may learn a handover failure pattern associated with other end devices 130, which may share (in whole or in part) a similar pre-serving mobility path as end device 130 to serving access device 107. According to an exemplary embodiment, source access device 107 may select the target access device 107 with the best handover performance (e.g., lowest handover failure rate) in view of the historical pre-serving mobility path and connections and the historical performance of handovers between source/serving access device 107 and each candidate target access device 107.

Referring back to FIG. 5A, in block 555, source access device 107 may execute a handover procedure with the selected target access device 107. The handover procedure may include steps or operations previously described in relation to block 345 of FIG. 3. Process 500 may end.

FIG. 5A illustrates an exemplary process 500 of the handover failure minimization service, according to other exemplary embodiments, the handover failure minimization service may perform additional operations, fewer operations, and/or different operations than those illustrated and described.

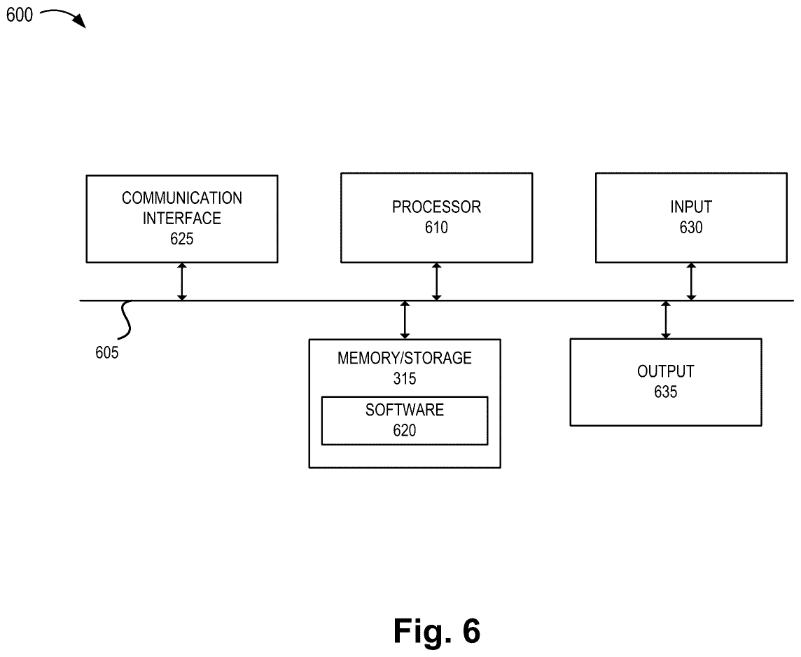

FIG. 6 is a diagram illustrating exemplary components of a device that may correspond to one or more of the devices illustrated and described herein. For example, device 600 may correspond to access device 107, external device 117, core device 122, end device 130, gNB 202-1, and/or other types of network devices, as described herein. As illustrated in FIG. 6, device 600 includes a bus 605, a processor 610, a memory/storage 615 that stores software 620, a communication interface 625, an input 630, and an output 635. According to other embodiments, device 600 may include fewer components, additional components, different components, and/or a different arrangement of components than those illustrated in FIG. 6 and described herein.

Bus 605 includes a path that permits communication among the components of device 600. For example, bus 605 may include a system bus, an address bus, a data bus, and/or a control bus. Bus 605 may also include bus drivers, bus arbiters, bus interfaces, clocks, and so forth.

Processor 610 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), quantum processors, future generation processors or execution environments, and/or some other type of component that interprets and/or executes instructions and/or data. Processor 610 may be implemented as hardware (e.g., a microprocessor, etc.), a combination of hardware and software (e.g., a SoC, an ASIC, etc.), may include one or multiple memories (e.g., cache, etc.), etc.

Processor 610 may control the overall operation, or a portion of operation(s) performed by device 600. Processor 610 may perform one or multiple operations based on an operating system and/or various applications or computer programs (e.g., software 620). Processor 610 may access instructions from memory/storage 615, from other components of device 600, and/or from a source external to device 600 (e.g., a network, another device, etc.). Processor 610 may perform an operation and/or a process based on various techniques and/or technologies including, for example, multithreading, parallel processing, pipelining, interleaving, machine learning, artificial intelligence, etc.

Memory/storage 615 includes one or multiple memories and/or one or multiple other types of storage mediums. For example, memory/storage 615 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 615 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 615 may be external to and/or removable from device 600, such as, for example, a Universal Serial Bus (USB) memory stick, a dongle, a hard disk, a solid state drive, mass storage, off-line storage, cloud storage, or some other type of storing medium. Memory/storage 615 may store data, software, and/or instructions related to the operation of device 600.

Software 620 includes an application or a program that provides a function and/or a process. As an example, with reference to core device 122, software 620 may include an application that, when executed by processor 610, provides a function and/or a process of handover failure minimization service, as described herein. According to another example, with reference to AI/ML platform 275, software 620 may include an application that, when executed by processor 610, provides a function and/or a process of handover failure minimization service, as described herein. Software 620 may also include firmware, middleware, microcode, hardware description language (HDL), and/or other form of instruction. Software 620 may also be virtualized. Software 620 may further include an operating system.

Communication interface 625 permits device 600 to communicate with other devices, networks, systems, and/or the like. Communication interface 625 includes one or multiple wireless interfaces, optical interfaces, and/or wired interfaces. For example, communication interface 625 may include one or multiple transmitters and receivers, or transceivers. Communication interface 625 may operate according to a protocol stack and a communication standard.

Input 630 permits an input into device 600. For example, input 630 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 635 permits an output from device 600. For example, output 635 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 600 may be implemented in the same manner. For example, device 600 may be instantiated, created, spun-up, uninstantiated, deleted, spun-down, or some other operational state during its life cycle (e.g., refreshed, paused, suspended, rebooting, or another type of state or status), using well-known virtualization technologies. For example, access device 107, core device 122, external device 117, and/or another type of network device or end device 130, as described herein, may be a virtualized device.

Device 600 may perform a process and/or a function, as described herein, in response to processor 610 executing software 620 stored by memory/storage 615. By way of example, instructions may be read into memory/storage 615 from another memory/storage 615 (not shown) or read from another device (not shown) via communication interface 625. The instructions that are stored by memory/storage 615 may configure and cause processor 610 to perform a function or a process described herein. Alternatively, for example, according to other implementations, device 600 performs a function or a process described herein based on the execution of hardware (processor 610, etc.).

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” The term “substantially” is used herein to represent a degree by which a quantitative representation may vary from a stated reference without resulting in a change in the basic function of the subject matter at issue.

Any embodiment or implementation described as “exemplary” is not necessarily to be construed as preferred or advantageous over other embodiments or implementations.

In addition, while series of blocks have been described regarding the processes illustrated in FIGS. 3-5, the order of the blocks may be modified according to other embodiments. Further, non-dependent blocks may be performed in parallel. Additionally, other processes described in this description and illustrated in the drawings may be modified and/or non-dependent operations may be performed in parallel.

Embodiments described herein may be implemented in many different forms of software executed by hardware. For example, a process or a function may be implemented as “logic” or a “component.” The logic or the component may include, for example, hardware (e.g., processor 610, etc.), or a combination of hardware and software (e.g., software 620).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 610) of a device. A non-transitory storage medium includes one or more of the storage mediums described in relation to memory/storage 615. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later become known are expressly incorporated herein by reference and are intended to be encompassed by the claims.

What is claimed is:

1. A method comprising:
determining, by a source radio access network (RAN) device that includes a model, to invoke a handover decision procedure associated with an end device;
calculating, by the model of the source RAN device, a probability of handover failure for candidate target RAN devices;
selecting, by the source RAN device, one of the candidate target RAN devices that has at least one of a lowest probability of handover failure or a historically lowest handover failure rate; and
performing, by the source RAN device, a handover procedure with the one of the candidate target RAN devices.

2. The method of claim 1, further comprising:
determining, by the source RAN device, that at least two of the candidate target RAN devices have probability of handover failure that are equivalent; and
determining, by the source RAN device, which of the at least two of the candidate target RAN devices has the historically lowest handover failure rate with the source RAN device.

3. The method of claim 1, further comprising:
comparing, by the source RAN device, the probability of handover failure to a threshold probability of handover failure, which indicates a significant probability that handover will fail; and
determining, by the source RAN device based on the comparing, whether the probability of handover failure satisfies the threshold probability of handover failure.

4. The method of claim 1, further comprising:
obtaining, by the source RAN device from the candidate target RAN devices, one or more key performance indicators (KPIs) indicative of handover failure; and
using, by the source RAN device, the one or more KPIs to determine a historical handover failure rate.

5. The method of claim 4, wherein the one or more KPIs include handover preparation attempts.

6. The method of claim 1, wherein the historically lowest handover failure rate pertains to a pre-serving RAN device relative to the source RAN device, the source RAN device, and the one of the candidate target RAN devices.

7. The method of claim 1, wherein the model is configured to minimize false negative predictions associated with handovers.

8. The method of claim 1, wherein the source RAN device is a next generation Node B (gNB) or a split RAN device.

9. A network device comprising:
a processor that is configured to:
determine to invoke a handover decision procedure associated with an end device, wherein the network device is a source radio access network (RAN) device that includes a model;
calculate via the model, a probability of handover failure for candidate target RAN devices;
select one of the candidate target RAN devices that has at least one of a lowest probability of handover failure or a historically lowest handover failure rate; and
perform a handover procedure with the one of the candidate target RAN devices.

10. The network device of claim 9, wherein the processor is further configured to:
determine that at least two of the candidate target RAN devices have probability of handover failure that are equivalent; and
determine which of the at least two of the candidate target RAN devices has the historically lowest handover failure rate with the source RAN device.

11. The network device of claim 9, wherein the processor is further configured to:
compare, the probability of handover failure to a threshold probability of handover failure, which indicates a significant probability that handover will fail; and
determine, based on the comparison, whether the probability of handover failure satisfies the threshold probability of handover failure.

12. The network device of claim 9, wherein the processor is further configured to:
obtain, from the candidate target RAN devices, one or more key performance indicators (KPIs) indicative of handover failure; and
use the one or more KPIs to determine a historical handover failure rate.

13. The network device of claim 12, wherein the one or more KPIs include handover preparation attempts.

14. The network device of claim 9, wherein the historically lowest handover failure rate pertains to a pre-serving RAN device relative to the source RAN device, the source RAN device, and the one of the candidate target RAN devices.

15. The network device of claim 9, wherein the model is configured to minimize false negative predictions associated with handovers.

16. The device of claim 9, wherein the source RAN device is a next generation Node B (gNB) or a split RAN device.

17. A non-transitory computer-readable storage medium storing instructions executable by a processor of a source radio access network (RAN) device that includes a model, wherein the instructions are configured to:
determine to invoke a handover decision procedure associated with an end device;
calculate via the model, a probability of handover failure for candidate target RAN devices;
select one of the candidate target RAN devices that has at least one of a lowest probability of handover failure or a historically lowest handover failure rate; and
perform a handover procedure with the one of the candidate target RAN devices.

18. The non-transitory computer-readable storage medium of claim 17, wherein the instructions include further instructions that are configured to:
determine that at least two of the candidate target RAN devices have probability of handover failure that are equivalent; and
determine which of the at least two of the candidate target RAN devices has the historically lowest handover failure rate with the source RAN device.

19. The non-transitory computer-readable storage medium of claim 17, wherein the historically lowest handover failure rate pertains to a pre-serving RAN device relative to the source RAN device, the source RAN device, and the one of the candidate target RAN devices.

20. The non-transitory computer-readable storage medium of claim 17, wherein the model is configured to minimize false negative predictions associated with handovers.
